(19) United States
(12) Patent Application Publication
(10) Pub. No.: US 2025/0096587 A1
(43) Pub. Date: Mar. 20, 2025

(54) PORTABLE POWER SUPPLY WITH AUTOMATIC START

(71) Applicant: MILWAUKEE ELECTRIC TOOL CORPORATION, Brookfield, WI (US)

(72) Inventors: Jeffrey M. Brozek, Mequon, WI (US); Jascha L. Reyes, Milwaukee, WI (US); Nelson C. Arias Rotunno, Pewaukee, WI (US); Samantha L. Billetdeaux, New Berlin, WI (US); Logan Matthew Manderle, Milwaukee, WI (US)

(21) Appl. No.: 18/809,882

(22) Filed: Aug. 20, 2024

Related U.S. Application Data
(60) Provisional application No. 63/583,343, filed on Sep. 18, 2023.

(51) Int. Cl. H02J 7/00

(52) U.S. Cl. CPC H02J 7/00712; H02J 7/00032; H02J 7/0042; H02J 7/0047; H02J 7/0048; H02J 7/0063; H02J 7/0068

(57) ABSTRACT

Portable power supply with automatic start. The portable power supply includes a power source, an outlet electrically coupled to the power source and configured to connect to a load, and an electronic processor coupled to the power source and the outlet. The electronic processor is configured to automatically enable the outlet in response to a state of charge (SOC) of the power source satisfying an automatic start threshold.

### RELATED APPLICATIONS

This application claims priority to U.S. Provisional Application No. 63/583,343, filed on Sep. 18, 2023, the entire content of which is hereby incorporated by reference.

### BACKGROUND

The present disclosure relates to a portable power supply, and, in particular, a portable power supply with an automatic start feature.

### SUMMARY

One embodiment provides a portable power supply that may include a power source, and an outlet electrically coupled to the power source and configured to connect to a load. The portable power supply may also include an electronic processor coupled to the power source and the outlet. The electronic processor may be configured to control charging of the power source using power provided by an external power source. The electronic processor also may be configured to enable an automatic start feature. When the automatic start feature is enabled, the electronic processor may be configured to disable the outlet in response to a state of charge (SOC) of the power source being below a low battery threshold, and automatically reenable the outlet in response to the SOC of the power source increasing above an automatic start threshold during charging. The automatic start threshold may be greater than the low battery threshold. The electronic processor also may be configured to disable the automatic start feature. When the automatic start feature is disabled, the electronic processor may be configured to disable the outlet in response to the SOC of the power source being below a low battery threshold, and keep the outlet disabled in response to the SOC of the power source increasing above the automatic start threshold during charging.

In addition to any combination of features described above, the portable power supply, may include a user interface communicatively coupled to the electronic processor. The electronic processor may be further configured to control the user interface to provide an indication that the automatic start feature of the portable power supply is enabled in response to the automatic start feature being enabled and while the automatic start feature remains enabled.

In addition to any combination of features described above, the electronic processor may be further configured to receive an updated threshold value via a user input received by the user interface, and update the automatic start threshold according to the updated threshold value.

In addition to any combination of features described above, the electronic processor may be further configured to receive a command via a user input received by the user interface, and control whether the automatic start feature is enabled or disabled based on the command.

In addition to any combination of features described above, the portable power supply may include a wireless communication device. The electronic processor may be communicatively coupled to the wireless communication device and may be further configured to receive an updated threshold value, via the wireless communication device, from an external device, and update the automatic start threshold according to the updated threshold value.

In addition to any combination of features described above, the portable power supply may include a wireless communication device. The electronic processor may be communicatively coupled to the wireless communication device and may be further configured to receive a command, via the wireless communication device, from an external device, and control whether the automatic start feature of the portable power supply is enabled or disabled based on the command.

Another embodiment provides a portable power supply that may include a power source, and an outlet electrically coupled to the power source and configured to connect to a load. The portable power supply also may include an electronic processor coupled to the power source and the outlet. The electronic processor may be configured to automatically enable the outlet in response to a state of charge (SOC) of the power source satisfying an automatic start threshold.

In addition to any combination of features described above, the portable power supply may include a user interface communicatively coupled to the electronic processor. The electronic processor may be further configured to control the user interface to provide an indication that an automatic start feature of the portable power supply is enabled in response to the automatic start feature being enabled and while the automatic start feature remains enabled. The electronic processor may be configured to automatically enable the outlet in response to the SOC of the power source satisfying the automatic start threshold when the automatic start feature is enabled.

In addition to any combination of features described above, the electronic processor may be further configured to receive an updated threshold value via a user input received by the user interface, and update the automatic start threshold according to the updated threshold value.

In addition to any combination of features described above, the electronic processor may be further configured to receive a command via a user input received by the user interface, and control whether the automatic start feature is enabled or disabled based on the command.

In addition to any combination of features described above, the portable power supply may include a housing configured to house the power source and the electronic processor. The outlet may be located on the housing. A receptacle may be disposed on the housing and electrically coupled to the power source. The external power source may be coupled to the receptacle by a power cord. The receptacle may be configured to facilitate charging of the power source.

In addition to any combination of features described above, the portable power supply may include a wireless communication device. The electronic processor may be communicatively coupled to the wireless communication device and may be further configured to receive an updated threshold value, via the wireless communication device, from an external device, and update the automatic start threshold according to the updated threshold value.

In addition to any combination of features described above, the portable power supply may include a wireless communication device. The electronic processor may be communicatively coupled to the wireless communication device and may be further configured to receive a command, via the wireless communication device, from an external device, and control whether an automatic start feature of the portable power supply is enabled or disabled based on the command. The electronic processor may be configured to automatically enable the outlet in response to the SOC of the power source satisfying the automatic start threshold when the automatic start feature is enabled.

In addition to any combination of features described above, the outlet may be configured to provide alternating current (AC) to the load.

In addition to any combination of features described above, the power source may include a plurality of battery cells.

In addition to any combination of features described above, the electronic processor may be configured to determine the SOC of the power source while the power source is charging.

In addition to any combination of features described above, the electronic processor may be configured to enable an automatic start feature. When the automatic start feature is enabled, the electronic processor may be configured to disable the outlet in response to the SOC of the power source being below a low battery threshold, and automatically reenable the outlet in response to the SOC of the power source increasing above the automatic start threshold during charging. The automatic start threshold may be greater than the low battery threshold.

In addition to any combination of features described above, the electronic processor may be configured to disable the automatic start feature. When the automatic start feature is disabled, the electronic processor may be configured to disable the outlet in response to the SOC of the power source being below a low battery threshold, and keep the outlet disabled in response to the SOC of the power source increasing above the automatic start threshold during charging.

Another embodiment provides a method of controlling a portable power supply. The method may include electrically coupling a power source of the portable power supply to an external power source. The method may also include charging the power source using power provided by the external power source. The method may also include automatically enabling, with an electronic processor of the portable power supply, an outlet of the portable power supply in response to a state of charge (SOC) of the power source satisfying an automatic start threshold. The outlet many be electrically coupled to the power source and may be configured to connect to a load.

In addition to any combination of features described above, the method may further include enabling, with the electronic processor, an automatic start feature that utilizes the automatic start threshold. When the automatic start feature is enabled, the method may include disabling, with the electronic processor, the outlet in response to a state of charge (SOC) of the power source being below a low battery threshold, and automatically reenabling, with the electronic processor, the outlet in response to the SOC of the power source increasing above an automatic start threshold during charging. The automatic start threshold may be greater than the low battery threshold. The method may also include disabling, with the electronic processor, the automatic start feature. When the automatic start feature is disabled, the method may include disabling, with the electronic processor, the outlet in response to the SOC of the power source being below a low battery threshold, and keeping, with the electronic processor, the outlet disabled in response to the SOC of the power source increasing above the automatic start threshold during charging.

Other features and aspects of the disclosure will become apparent by consideration of the detailed description and accompanying drawings.

### BRIEF DESCRIPTION OF THE DRAWINGS

FIG. 1 is a front elevation view of a portable power supply according to embodiments disclosed herein.

FIG. 2 is a detailed perspective view of the portable power supply of FIG. 1, showing the outlet panel removed.

FIG. 3 illustrates a user interface for the portable power supply of FIG. 1.

FIG. 4 is a simplified block diagram showing an example power flow for the portable power supply of FIG. 1.

FIG. 5 illustrates a hardware schematic for the portable power supply of FIG. 1.

FIG. 6 illustrates a flowchart of a method for the portable power supply of FIG. 1 to provide power based on an input to engage an automatic start feature.

### DETAILED DESCRIPTION

Before any embodiments of the disclosure are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

Battery-powered portable power supplies (“portable power supplies”) are used in place of gas-powered generators to power or charge electrical loads such as power tools, computers, cell phones, or the like. Portable power supplies may include various kinds of outlets, for example, an alternating current (AC) outlet, a universal serial bus (USB), a 12 Volt outlet, or the like. A power button is provided on the portable power supply to turn the portable power supply on or off. When the portable power supply is on, the outlets are enabled such that electrical power from the portable power source can be used to power a connected load. When the portable power supply is off, the outlets are disabled such that no electrical power can be provided from the outlets. The power button allows a user to selectively turn the portable power supply on or off.

Portable power supplies may include a simultaneous charging and discharging feature where the batteries of the portable power supplies may be charged and discharged at the same time. The simultaneous charging and discharging feature allows for increased usability of the portable power supply such that the downtime due to charging of the portable power supply may be reduced.

When powering loads, the portable power supply may automatically turn off, that is, disable the outlets when the batteries reach a low voltage threshold. In these instances, the user will have to use the power button to turn the power supply back on before the power supply can be used again to output electrical power. Accordingly, there is a need for portable power supplies with automatic start.

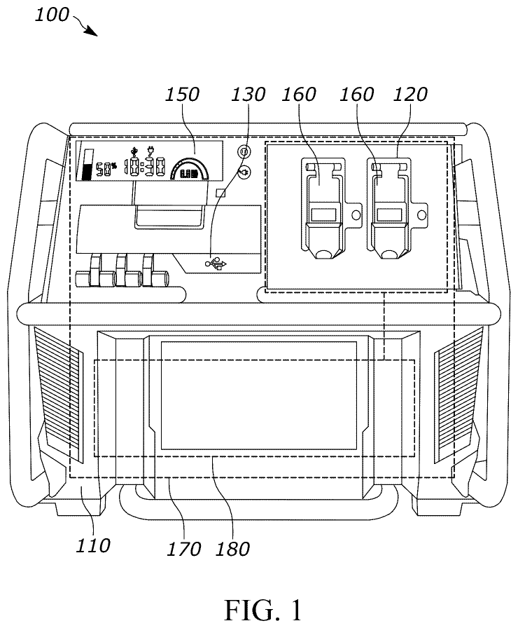

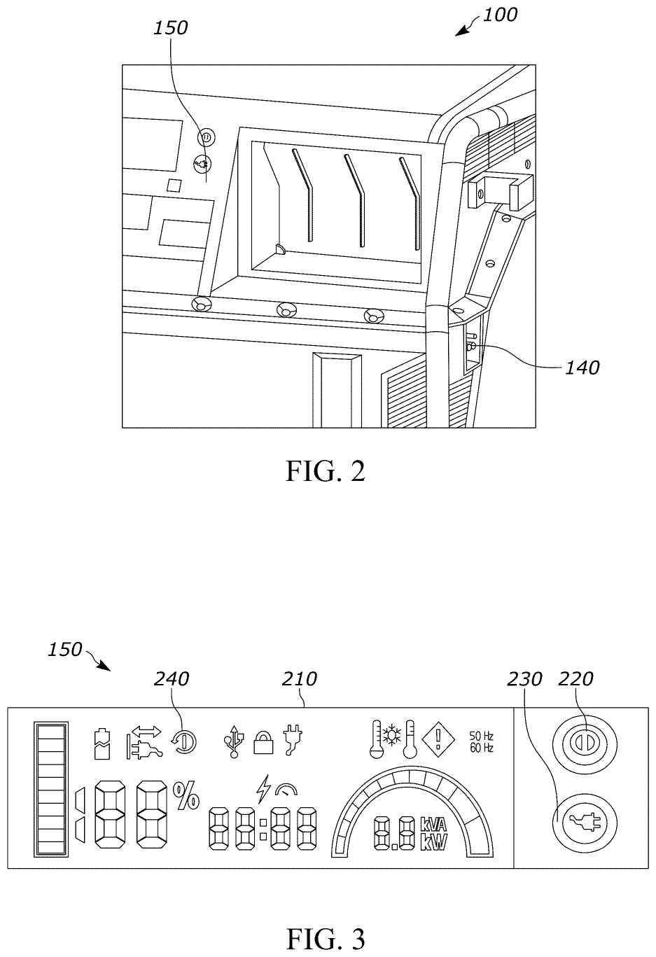

FIGS. 1 and 2 illustrate an embodiment of a portable power supply 100. The portable power supply 100 is suitable for providing power at a remote location such as a worksite. Where a permanent power supply such as mains power (e.g., electrical grid outlet) is not available (or not within reach), and power is required in order to operate electrically powered tools, the portable power supply 100 may provide power to be used by those tools. The portable power supply 100 may provide alternating current (AC) power to tools such as corded drills, saws, and the like and battery-charging units and/or direct current (DC) power for DC-powered tools. The portable power supply 100 includes a housing 110, an outlet panel assembly 120, one or more DC outlets 130, a receptacle 140, and a user interface panel 150. The outlet panel assembly 120, the one or more DC outlets 130, the receptacle 140, and the user interface panel 150 are provided/disposed on the housing 110. The housing 110 may be made of a durable material, such as metal, plastic, or the like, that is capable of withstanding scratches, dents, or other similar wear common to a worksite. The outlet panel assembly 120 includes one or more electrical outlets 160. In the example illustrated, the one or more electrical outlets 160 include alternating current (AC) power outlets similar to wall outlets. In some examples, the outlets 160 may include other types of outlets. The outlet panel assembly 120 may be a modular outlet panel assembly that is replaceable by another outlet panel assembly 120 having a similar or different configuration of outlets 160. The DC outlets 130 and the electrical outlets 160 may be collectively referred to as outlets 130, 160 or electrical outlets 130, 160.

The one or more DC outlets 130 include, for example, a universal serial bus (USB) outlet (e.g., USB-C, USB-A, mini-USB, or the like), a 12 Volts outlet, or the like. The receptacle 140 may include or receive a power cord that can be plugged into a wall outlet to receive mains AC electric power for charging the portable power supply 100. The housing 110 may form a cavity 170. A power source 180 is received within the cavity 170. The power source 180 may include a plurality of battery cells, for instance, lithium-ion battery cells or the like. In some examples, the power source 180 includes a battery core having a plurality of battery cells. The plurality of battery cells may be connected in a series-parallel configuration based on the desired output voltage of the portable power supply 100. In one example, the plurality of battery cells are connected in a 28S5P configuration. The 28S5P configuration includes five (5) strings of battery cells connected in parallel with each string of battery cells including twenty-eight (28) series connected battery cells. Other configurations may be used depending on the desired output voltage, capacity, and other related factors. In some examples, the power source 180 may include removable battery packs in place of or in addition to the battery core. The removable battery packs may include power tool battery packs.

FIG. 3 illustrates an embodiment of the user interface panel 150, which includes a display 210, an on/off switch 220 (e.g., main power switch 220), and an AC output button 230. The display 210 provides indications relating to the portable power supply 100 to an operator, for example, a state of charge (SOC) of the internal power source 180, a run time, a temperature, an instantaneous or average power output, a charge status, a discharge status, an AC output frequency, fault conditions, and/or the like. The user interface panel 150 includes various controls (e.g., buttons, switches, displays, indicators, etc.) to allow an operator to control operation of the portable power supply 100. The display 210 includes one or more light-emitting diode (LED) indicators configured to illuminate and display the various indications as noted above. In some embodiments, the display 210 is a liquid crystal display (LCD), an LED display, an organic LED (OLED) display, an electroluminescent display (ELD), a surface-conduction electron-emitter display (SED), a field emission display (FED), a thin-film transistor (TFT) LCD, an electronic ink (e-ink) display, and/or the like.

The on/off switch 220 can be actuated to turn the portable power supply 100 on or off depending on the current state of the device. In some embodiments, a user can enable an automatic start feature by continuing to actuate, for example the on/off switch 220, the AC output button 230, or another button (for example, a USB output button), or some combination of simultaneous or sequential pressing of these and other buttons for a threshold time (e.g., hold the on/off switch 220 for 5 seconds). The icon 240 indicates the status of the automatic start feature. For example, icon 240 may be provided when the automatic start feature is enabled and not provided when the automatic start feature is disabled. In other words, the icon 240 may be illuminated (e.g., in a solid manner or in a flashing manner) in response to the automatic start feature being enabled and while the automatic start feature remains enabled. In some cases, the automatic start feature can be disabled based on a state of the portable power supply 100 (e.g., when the AC load is over a threshold, or when an internal temperature or battery temperature is over a threshold).

The AC output button 230 can be actuated to enable the AC inverter. For example, a user can press the on/off switch 220 first and then press the AC output button 230 to enable AC output. In some embodiments, the portable power supply 100 may not include the AC output button 230 and a user can enable AC output by pressing just the on/off switch 220. In some embodiments, additional buttons, for example, a USB output button, or the like may be provided on the interface panel 150. The USB output button can be actuated to enable the USB outlets (for example, the DC outlets 130). In some embodiments, the portable power supply 100 may not include the display 210. In the illustrated embodiment, the user interface panel 150 is positioned adjacent a first sidewall of the housing 110. In other embodiments, the user interface panel 150 may be positioned in other places, including inside the cavity 170.

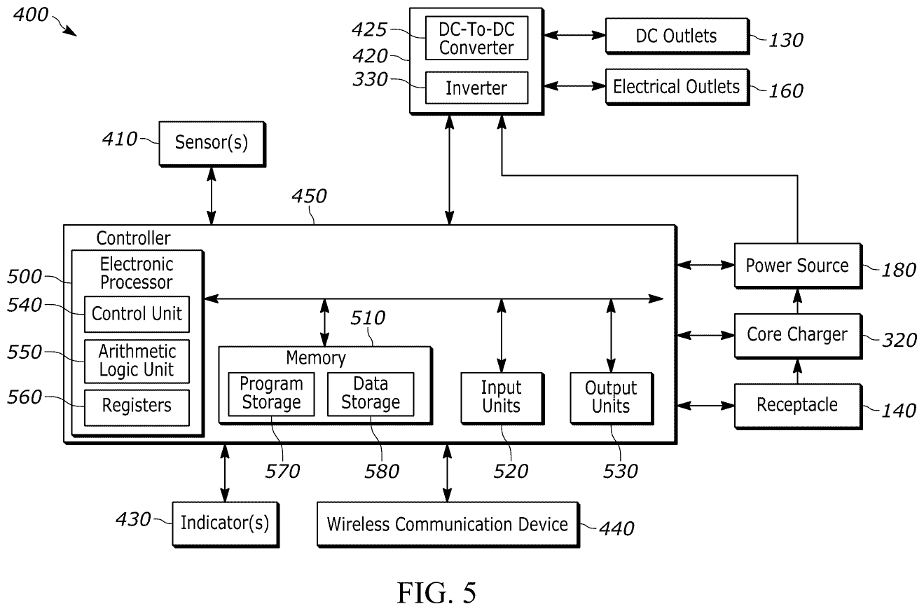

In some embodiments, the portable power supply 100 may include a wireless transceiver (see FIG. 5) to wirelessly communicate commands and data between the portable power supply 100 and an external device (e.g., a smart telephone, a tablet computer, a cellular phone, a laptop computer, a smart watch, and the like). In these embodiments, the user interface panel 150 may be integrated (or mirrored) in a mobile application communicating with the portable power supply 100 using a wireless communication protocol (e.g., Bluetooth®).

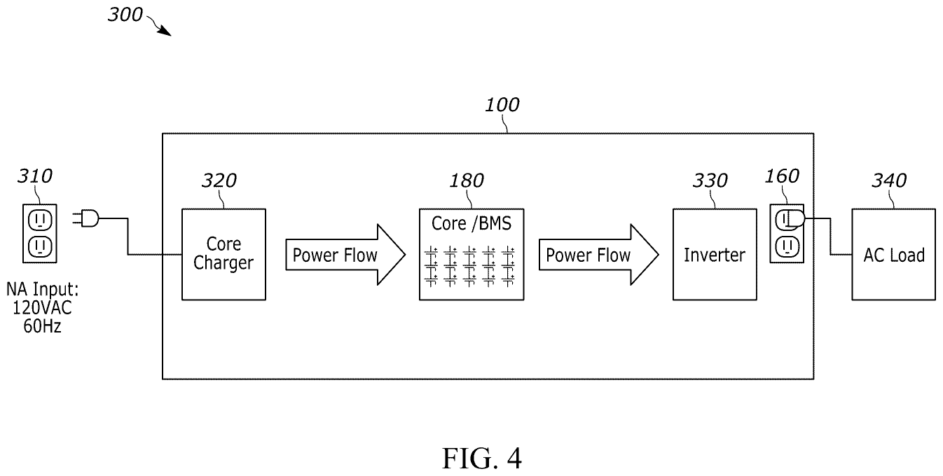

FIG. 4 is a simplified block diagram showing an example power flow 300 for the power supply 100. The portable power supply 100 is connected to an AC wall outlet 310 (e.g., external power source) using a power cord via the receptacle 140 (see FIG. 2). The AC power received from the AC wall outlet 310 is provided to the core charger 320 for charging the power source 180. In some examples, an AC-to-DC converter may be included in the core charger 320 to convert the AC power to DC power to charge the power source 180. The DC power from the power source 180 is provided to the inverter 330. The inverter 330 converts the DC power from the power source 180 to be provided to the outlets 160. The outlets 160 are used to power electrical loads 340, for example, power tools. In the example illustrated, the power source 180 is capable of simultaneous charging and discharging. However, in some instances, no pass through power may flow directly from the receptacle 140 to the outlets 160. The power source 180 may therefore be charged while providing output power to connected electrical loads 340. In some examples, portable power supply 100 charges automatically (i.e., without user input) when the power cord is plugged into a 120 VAC power source (e.g., the AC wall outlet 310).

In other examples, a by-pass pathway may be provided between the receptacle 140 and the outlets 160 to provide pass through power to the outlets 160 when the power source 180 is charging. In some examples, power output from the power source 180 may be terminated during charging of the power source 180.

FIG. 5 shows a hardware schematic 400 for the portable power supply 100 including the core charger 320, a plurality of sensors 410, a power converter 420, a plurality of indicators 430, and a wireless communication device 440 communicatively coupled to a controller 450. The controller 450 controls the core charger 320 to charge the power source 180. For example, the controller 450 controls the power conversion and a charging scheme (e.g., constant voltage, constant current, or the like) of the core charger 320 to charge the power source 180. The sensors 410 are configured to sense electrical characteristics of the power supply 100 (e.g., voltage of the power source 180, the state of charge (SOC) of the power source 180, the current output of the power supply 100, temperature of the power supply 100 and/or the like).

The power converter 420 includes the inverter 330 and a DC-to-DC converter 425. The inverter 330 provides an AC output to, for example, electrical outlets 160. The inverter 330 includes a power switching network having a plurality of switches (e.g., field effect transistors “FETS”). The controller 450 controls the plurality of switches using, for example, pulse width modulated (PWM) control signals provided to the gates of the plurality of switches. The controller 450 controls the inverter 330 to convert the DC power from the power source 180 to AC power to be provided through the electrical outlets 160. The DC-to-DC converter 425 may include a flyback converter, an active clamp flyback converter, a boost/buck converter, or the like to convert the DC power from the power source 180 at a first voltage to a DC power at a second voltage to be provided to the DC outlets 130. The electrical components of the power supply 100 may be powered using input from either the receptacle 140 or the power source 180.

The indicators 430 receive control signals from the controller 450 to generate a visual signal to convey information regarding the operation or state of the portable power supply 100 to the user. The indicators 430 may be provided on, for example, the user interface panel 150. The indicators 430 may generate various signals indicative of, for example, an operational state or mode of the portable power supply 100 (e.g., that the automatic start feature is enabled via the icon 240), an abnormal condition or event detected during the operation of the portable power supply 100, and so forth.

The controller 450 is electrically and/or communicatively connected to a variety of modules or components of the portable power supply 100. In some embodiments, the controller 450 includes a plurality of electrical and electronic components that provide power, operational control, and protection to the components and modules within the controller 450 and/or the portable power supply 100. For example, the controller 450 includes, among other things, an electronic processor 500 (e.g., a microprocessor, a microcontroller, electronic processor, or another suitable programmable device), a memory 510, input units 520, and output units 530. The electronic processor 500 includes, among other things, a control unit 540, an arithmetic logic unit (ALU) 550, and a plurality of registers 560. In some embodiments, the controller 450 is implemented partially or entirely on a semiconductor (e.g., a field-programmable gate array (FPGA) semiconductor) chip or an Application Specific Integrated Circuit (ASIC), such as a chip developed through a register transfer level (RTL) design process. Although the electronic processor 500 is shown as a component of the controller 450, in some instances, the controller 450 may itself be referred to as an electronic processor. The controller 450 may have additional or alternative components and/or may have its components arranged in different manners than that shown in FIG. 5.

The controller 450 is configured to retrieve from the memory 510 and execute, among other things, instructions related to the control processes and methods described herein. The memory 510 includes, for example, a program storage area 570 and a data storage area 580. The program storage area 570 and the data storage area 580 can include combinations of different types of memory, such as read-only memory (ROM), random access memory (RAM) (e.g., dynamic RAM (DRAM), synchronous DRAM (SDRAM), and the like), electrically erasable programmable read-only memory (EEPROM), flash memory, a hard disk, an SD card, or other suitable magnetic, optical, physical, or electronic memory devices. The controller 450 is connected to the memory 510 and executes software instructions that are capable of being stored in a RAM of the memory 510 (e.g., during execution), a ROM of the memory 510 (e.g., on a generally permanent basis), or another non-transitory computer readable medium such as another memory or a disc. Software included in the implementation of the portable power supply 100 can be stored in the memory 510 of the controller 450. The software includes, for example, firmware, one or more applications, program data, filters, rules, one or more program modules, and other executable instructions.

The wireless communication device 440 is coupled to the controller 450. The wireless communication device 440 may include, for example, a wireless transceiver and antenna, a memory, a processor, and a real-time clock. The radio transceiver and antenna operate together to send and receive wireless messages to and from an external device, such as described above. The memory of the wireless communication device 440 stores instructions to be implemented by the processor of the wireless communication device 440 and/or may store data related to communications between the portable power supply 100 and the external device. The processor for the wireless communication device 440 controls wireless communications between the portable power supply 100 and the external device (for example, a smartphone running a mobile application relating to the portable power supply 100). For example, the processor of the wireless communication device 440 buffers incoming and/or outgoing data, communicates with the controller 450, and determines the communication protocol and/or settings to use in wireless communications.

In some embodiments, the wireless communication device 440 is a Bluetooth® controller. The Bluetooth® controller communicates with the external device employing the Bluetooth® protocol. In such embodiments, therefore, the external device and the portable power supply 100 are within a communication range of each other while they exchange data. In other embodiments, the wireless communication device 440 communicates using other protocols (e.g., Wi-Fi, cellular protocols, a proprietary protocol, and so forth) over a different type of wireless network. For example, the wireless communication device 440 may be configured to communicate via Wi-Fi through a wide area network such as the Internet or a local area network, or to communicate through a piconet (e.g., using infrared or Near-field communication (NFC)). The communication via the wireless communication device 440 may be encrypted to protect the data exchanged between the portable power supply 100 and the external device from third parties.

In some instances, an external device that is configured to communicate with the portable power supply 100 may include similar components with similar functionality as those described herein with respect to FIG. 5. For example, the external device may include a controller similar to controller 450 and a wireless communication device 440 similar to the wireless communication device 440. Additionally, the external device may include a display that is similar to the user interface panel 150. In some instances, the display may include a touch screen.

In some embodiments, the controller 450 is configured to control whether an automatically start feature of the portable power supply is enabled or disabled. The automatic start feature may utilize an automatic start threshold to automatically turn on the portable power supply 100 (e.g., to provide AC or DC power through the outlet 160) when the SOC of the power source 180 reaches the automatic start threshold, for example, during charging of the power source 180. In some embodiments, the automatic start threshold is set at the time of manufacture. In some cases, the automatic start threshold may be set to 10%, 15%, 20%, 30%, 35%, 40%, 45%, 50%, 55%, 60%, 70%, 75%, 80%, 85%, 90, 95%, or more. In some embodiments, the automatic start threshold is configurable. For example, the automatic start threshold may be set/updated by an operator via the user interface panel 150 or via an external device (e.g., via the mobile application) communicating via the wireless communication device 440.

In some embodiments, the controller 450 is configured to engage the automatic start feature when the portable power supply 100 is plugged into a power source (e.g., mains electric power is coupled to the receptacle 140 by a power cord or other power transmission apparatus) regardless of whether the portable power supply 100 is on or off (for example, regardless of the actuation state of the on/off switch 220). In some embodiments, the controller 450 is configured to engage the automatic start feature when a command is received from the user interface panel 150 or an external device. In some embodiments, the controller 450 is configured to engage the automatic start feature when the on/off switch 220 is engaged for a threshold time (e.g., 5 seconds).

In some embodiments, an operator may disable the automatic start feature (e.g., provide a command to the controller 450) via the user interface panel 150 or via an external device. In some embodiments, the user interface panel 150 is configured to display an icon 240 indicating that the automatic start feature is enabled. The user interface panel 150 may be configured not to display the icon 240 when the automatic start feature is disabled thereby indicating that the automatic start feature is disabled. In some instances, the user interface panel 150 may display a different icon or a modified version of the icon 240 (e.g., a line or an “X” through the icon 240) to indicate that the automatic start feature is disabled.

The automatic start feature allows the portable power supply 100 to continually cycle through charging and discharging power automatically. As an example, the controller 450 enables power output to the outlet 160 to provide power (turns on the portable power supply 100) when the SOC of the power source 180 reaches the set automatic start threshold. The controller 450 may control the power source 180 to simultaneous charge and discharge. Power is provided via the outlet 160 until the power source 180 is discharged below a predetermined threshold (e.g., fully discharged). The controller 450 disables the outlets 160 when the power source 180 is discharged below the predetermined threshold (e.g., fully discharged). The power source 180 continues to charge until the automatic start threshold (e.g., 80% SOC) is again met, at which point the controller 450 enables the outlet 160 to again provide power. The cycle may then repeat. In one example, the controller 450 uses the inverter 330 (or power converter 420) to enable and disable the outlets 130, 160. For example, the controller 450 disables control of the power converter 420 components to disable the outlets 130, 160. In some examples, a discharge control switch (e.g., a FET) may be provided between the power converter 420 and the outlets 130, 160. The controller 450 disables the outlets 130, 160 by opening the discharge control switch to prevent power flow between the power converter 420 and the outlets 130, 160. The controller 450 enables the outlets 130, 160 by closing the discharge control switch. In some examples, a subset of the outlets 130, 160 may be enabled and disabled using the automatic start feature rather than all of the outlets 130, 160 being enabled and disabled using the automatic start feature. The subset of outlets 130, 160 that are enabled and disabled using the automatic start feature may be selected via user input on the user interface panel 150 and/or via user input on the external device.

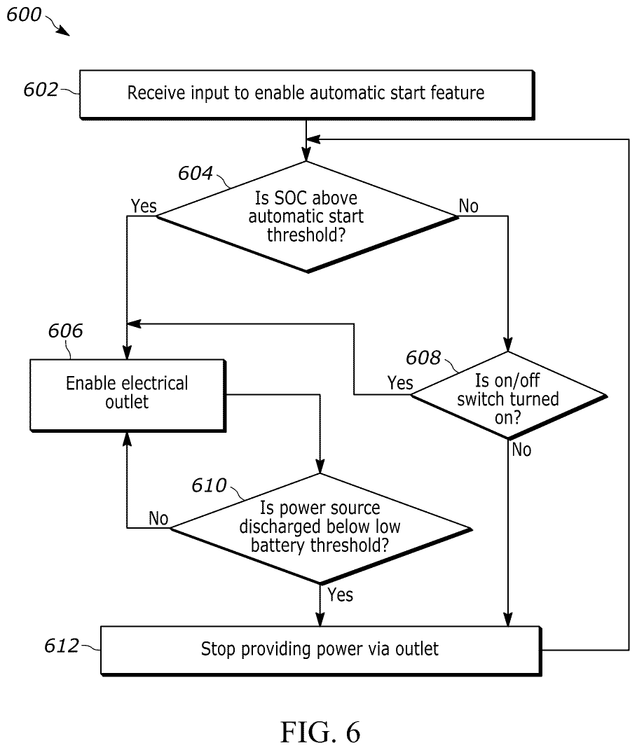

FIG. 6 depicts a flowchart of an example method 600. The example method 600 can be implemented by the components of the portable power supply 100 described above with respect to FIGS. 1-5. The example method 600 generally shows in more detail how the portable power supply 100 is configured to provide power via the electrical outlets 130, 160 when implementing the automatic start feature (e.g., after receiving an input to engage the automatic start feature).

For clarity of presentation, the description that follows generally describes the example method 600 in the context of FIGS. 1-5. The electronic processor that performs the method 600 may include any one or a combination of electronic processors located within a single device or distributed among various devices and/or systems (e.g., the portable power supply 100, the external device, etc.). Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed within a single device or across multiple devices. While a particular order of processing steps, message receptions, and/or message transmissions is indicated in FIG. 6 as an example, timing and ordering of such steps, receptions, and transmissions may vary where appropriate without negating the purpose and advantages of the examples set forth in detail throughout the remainder of this disclosure.

The method is described as being performed by the controller 450 of the portable power supply 100. However, it will be understood that the method 600 may be performed, for example, by any other suitable system, environment, software, and hardware, or a combination of systems, environments, software, and hardware as appropriate. In some embodiments, various operations of the method 600 can be run in parallel, in combination, in loops, or in any order. In some embodiments, various operations are optional. For example, in some cases, the portable power supply 100 is configured to continually implement the automatic start feature without receiving an input.

At block 602, the method 600 includes receiving, using the controller 450, an input to enable the automatic start feature. In some examples, the automatic start feature is enabled using the on/off switch 220 by holding (e.g., actuating) the on/off switch 220 continuously for a threshold time (e.g., 5 seconds). In other examples, the automatic start feature is enabled using an external device (e.g., by providing a user input to a display of the external device while the external device is running a mobile application associated with the portable power supply 100). In some examples, the automatic start feature may be automatically enabled unless turned off by a user via a user input. In other words, in some instances, block 602 may not be included in the method 600, and the automatic start feature may be enabled by default unless turned ff/disabled by the user via user input on the user interface panel 150 and/or via user input on the external device. From block 602, the method 600 proceeds to block 604.

At block 604, the method 600 includes determining, using the controller 450, whether the SOC of the power source 180 is above the automatic start threshold and whether the receptacle 140 is plugged in. The controller 450 compares the SOC of the power source 180 to the automatic start threshold (e.g., 80%). In some examples, a voltage of the power source 180 may be used as a proxy for the SOC. For example, the controller 450 compares an open circuit voltage or closed circuit voltage of the power source 180 to a voltage threshold to determine whether the SOC is above the automatic start threshold. The controller 450 also determines whether the receptacle 140 is plugged into a power source (e.g., the AC wall outlet) (i.e., whether the receptacle 140 is electrically connected to a power source to receive power from the power source). The controller 450 may determine that the receptacle 140 is plugged in based on detecting an input current through the receptacle 140. When both (i) the SOC is above (or equal to) the automatic start threshold (i.e., satisfies the automatic start threshold) and (ii) the receptacle 140 is plugged into a power source, the method 600 proceeds to block 606. When the SOC is below the automatic start threshold or when the receptacle 140 is not plugged in, the method 600 proceeds to block 608. In some examples, the automatic start threshold is user selectable. An updated automatic start threshold may be received via a user input at the user interface panel 150 or an external device. The controller 450 receives an updated threshold value (e.g., 80%→60%) and updates the automatic start threshold based on the updated threshold value.

At block 606, the method 600 includes enabling, using the controller 450, the electrical outlet 160 and/or the DC outlet 130. The controller 450 controls the power converter 420 and/or the discharge control switch to enable the outlets 130, 160. From block 606, the method 600 proceeds to block 610. The method 600 therefore facilitates automatic reenabling of the electrical outlets 130, 160 during simultaneous charging and discharging of the power source 180. The automatic start feature allows the AC output power to be automatically re-enabled regardless of whether the power supply 100 is turned on/off. For example, when the SOC of the power source 180 reaches the automatic start threshold during charging, the outlets 130, 160 may be automatically enabled (when the automatic start feature is enabled) even when the power supply 100 is turned off (that is, the on/off switch 220 is not turned on).

At block 608, the method 600 includes determining, using the controller 450, whether the on/off switch 220 is turned on. When the on/off switch 220 is turned on, the method 600 proceeds to block 606. When the on/off switch 220 is not actuated, the method 600 proceeds to block 612 to stop providing power to the electrical outlets 130, 160. In some examples, actuation of the on/off switch 220 may provide an interrupt signal to the controller 450. The controller 450 enables the outlets 130, 160 in response to receiving the interrupt signal (even when the SOC is below the automatic start threshold).

At block 610, the method 600 includes determining, using the controller 450, whether the power source 180 is discharged below a low battery threshold. The controller 450 may determine whether the power source 180 is discharged below a low battery threshold by using the voltage of the power source 180 or the state of charge of the power source 180. For example, the controller 450 compares the voltage of the power source 180 to a low battery voltage threshold to determine whether the power source 180 is discharged below the low battery threshold (e.g., fully discharged). The controller 450 may additionally or alternatively determine the state of charge to determine whether the power source 180 is discharged below the low battery threshold (e.g., fully discharged). In some examples, the low battery threshold is user selectable via user input on the user interface panel 150 and/or via user input on the external device. When the SOC is above the low battery threshold, the method 600 continues to enable the electrical outlets 130, 160 (at block 606) and to monitor a discharge status of the power source (at block 610) (e.g., after a time interval such as one second, one tenth of a second, or the like). On the other hand, when the power source 180 is discharged below the low battery threshold, the method 600 proceeds to block 612. As is evident from the description herein and FIG. 6, the automatic start threshold is greater than the low battery threshold.

At block 612, the method 600 includes disabling, using the controller 450, the electrical outlet 160 and/or the DC outlet 130. The controller 450 controls the power converter 420 and/or the discharge control switch to disable the outlets 130, 160. From block 612, the method 600 proceeds to block 604 to repeat. When the automatic start feature is disabled, the controller 450 does not automatically enable the electrical outlets 130, 160 even when the SOC of the power source 180 is above the automatic start threshold. Rather, the controller 450 keeps the electrical outlets 130, 160 disabled upon the SOC satisfying the automatic start threshold, and enables and disables the electrical outlets 130, 160 based on the position of the on/off switch 220 and/or the AC output button 230.

The method 600 may repeat until, for example, a command is received to disable the automatic start feature (not shown). In some instances, the controller 450 may automatically disable the automatic start feature in response to determining that the portable power supply 100 is no longer plugged into a power source (e.g., in response to determining that the receptacle 140 is no longer coupled to a power source). In some instances, the controller 450 may prevent power from being provided to the electrical outlets 130, 160 in response to the on/off switch 220 and/or the AC output button 230 being switched to the “off” position regardless of the block in the method 600 that the controller 450 is currently executing. In other words, a user input to disable power output from the electrical outlets 130, 160 may generate an interrupt in the method 600 that causes the method 600 to stop until a different user input (e.g., the on/off switch 220 and/or the AC output button 230 being switched to the “on” position, the automatic start feature being enabled via user input, etc.) is received by the portable power supply 100.

In the foregoing specification, specific embodiments have been described. However, various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a,” “has . . . a,” “includes . . . a,” or “contains . . . a” does not, without more constraints, preclude the existence of additional identical elements in the process, method, article, or apparatus that comprises, has, includes, contains the element.

The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

Thus, embodiments described herein provide, among other things, a portable power supply providing an automatic start feature for frictionless power supply operation. Various features and advantages are set forth in the following claims.

What is claimed is:

1. A portable power supply comprising:
a power source;
an outlet electrically coupled to the power source and configured to connect to a load; and
an electronic processor coupled to the power source and the outlet, the electronic processor configured to:
control charging of the power source using power provided by an external power source,
enable an automatic start feature, wherein when the automatic start feature is enabled, the electronic processor is configured to:
disable the outlet in response to a state of charge (SOC) of the power source being below a low battery threshold, and
automatically reenable the outlet in response to the SOC of the power source increasing above an automatic start threshold during charging, wherein the automatic start threshold is greater than the low battery threshold, and
disable the automatic start feature, wherein when the automatic start feature is disabled, the electronic processor is configured to:
disable the outlet in response to the SOC of the power source being below a low battery threshold, and
keep the outlet disabled in response to the SOC of the power source increasing above the automatic start threshold during charging.

2. The portable power supply of claim 1, further comprising:
a user interface communicatively coupled to the electronic processor,
wherein the electronic processor is further configured to control the user interface to provide an indication that the automatic start feature of the portable power supply is enabled in response to the automatic start feature being enabled and while the automatic start feature remains enabled.

3. The portable power supply of claim 2, wherein the electronic processor is further configured to:
receive an updated threshold value via a user input received by the user interface, and
update the automatic start threshold according to the updated threshold value.

4. The portable power supply of claim 2, wherein the electronic processor is further configured to:
receive a command via a user input received by the user interface, and
control whether the automatic start feature is enabled or disabled based on the command.

5. The portable power supply of claim 1, further comprising:
a wireless communication device,
wherein the electronic processor is communicatively coupled to the wireless communication device and further configured to:
receive an updated threshold value, via the wireless communication device, from an external device, and
update the automatic start threshold according to the updated threshold value.

6. The portable power supply of claim 1, further comprising:
a wireless communication device,
wherein the electronic processor is communicatively coupled to the wireless communication device and further configured to:
receive a command, via the wireless communication device, from an external device, and
control whether the automatic start feature of the portable power supply is enabled or disabled based on the command.

7. A portable power supply comprising:
a power source;
an outlet electrically coupled to the power source and configured to connect to a load; and
an electronic processor coupled to the power source and the outlet, the electronic processor configured to:
automatically enable the outlet in response to a state of charge (SOC) of the power source satisfying an automatic start threshold.

8. The portable power supply of claim 7, further comprising:
a user interface communicatively coupled to the electronic processor, wherein the electronic processor is further configured to:
control the user interface to provide an indication that an automatic start feature of the portable power supply is enabled in response to the automatic start feature being enabled and while the automatic start feature remains enabled, wherein the electronic processor configured to automatically enable the outlet in response to the SOC of the power source satisfying the automatic start threshold when the automatic start feature is enabled.

9. The portable power supply of claim 8, wherein the electronic processor is further configured to:
receive an updated threshold value via a user input received by the user interface, and
update the automatic start threshold according to the updated threshold value.

10. The portable power supply of claim 8, wherein the electronic processor is further configured to:
receive a command via a user input received by the user interface, and
control whether the automatic start feature is enabled or disabled based on the command.

11. The portable power supply of claim 7, further comprising:
a housing configured to house the power source and the electronic processor, wherein the outlet is located on the housing; and
a receptacle disposed on the housing and electrically coupled to the power source;
wherein an external power source is coupled to the receptacle by a power cord; and
wherein the receptacle is configured to facilitate charging of the power source.

12. The portable power supply of claim 7, further comprising:
a wireless communication device,
wherein the electronic processor is communicatively coupled to the wireless communication device and further configured to:
receive an updated threshold value, via the wireless communication device, from an external device, and
update the automatic start threshold according to the updated threshold value.

13. The portable power supply of claim 7, further comprising:
a wireless communication device,
wherein the electronic processor is communicatively coupled to the wireless communication device and further configured to:
receive a command, via the wireless communication device, from an external device, and
control whether an automatic start feature of the portable power supply is enabled or disabled based on the command, wherein the electronic processor is configured to automatically enable the outlet in response to the SOC of the power source satisfying the automatic start threshold when the automatic start feature is enabled.

14. The portable power supply of claim 7, wherein the outlet is configured to provide alternating current (AC) to the load.

15. The portable power supply of claim 7, wherein the power source comprises a plurality of battery cells.

16. The portable power supply of claim 7, wherein the electronic processor is configured to determine the SOC of the power source while the power source is charging.

17. The portable power supply of claim 7, wherein the electronic processor is configured to enable an automatic start feature, wherein when the automatic start feature is enabled, the electronic processor is configured to:
disable the outlet in response to the SOC of the power source being below a low battery threshold; and
automatically reenable the outlet in response to the SOC of the power source increasing above the automatic start threshold during charging, wherein the automatic start threshold is greater than the low battery threshold.

18. The portable power supply of claim 17, wherein the electronic processor is configured to disable the automatic start feature, wherein when the automatic start feature is disabled, the electronic processor is configured to:
disable the outlet in response to the SOC of the power source being below a low battery threshold; and
keep the outlet disabled in response to the SOC of the power source increasing above the automatic start threshold during charging.

19. A method of controlling a portable power supply, the method comprising:
electrically coupling a power source of the portable power supply to an external power source;
charging the power source using power provided by the external power source; and
automatically enabling, with an electronic processor of the portable power supply, an outlet of the portable power supply in response to a state of charge (SOC) of the power source satisfying an automatic start threshold, wherein the outlet is electrically coupled to the power source and is configured to connect to a load.

20. The method of claim 19, further comprising:
enabling, with the electronic processor, an automatic start feature that utilizes the automatic start threshold, wherein when the automatic start feature is enabled, the method includes:
disabling, with the electronic processor, the outlet in response to a state of charge (SOC) of the power source being below a low battery threshold, and
automatically reenabling, with the electronic processor, the outlet in response to the SOC of the power source increasing above an automatic start threshold during charging, wherein the automatic start threshold is greater than the low battery threshold; and
disabling, with the electronic processor, the automatic start feature, wherein when the automatic start feature is disabled, the method includes:
disabling, with the electronic processor, the outlet in response to the SOC of the power source being below a low battery threshold, and
keeping, with the electronic processor, the outlet disabled in response to the SOC of the power source increasing above the automatic start threshold during charging.
